(19) United States
(12) Patent Application Publication
(10) Pub. No.: US 2006/0288081 A1
(43) Pub. Date: Dec. 21, 2006

(54) Information storage medium including application for obtaining metadata and apparatus and method of obtaining metadata

(75) Inventors: Hyo-jin Sung, Seoul (KR); Bong-gil Bak, Suwon-si (KR); Kil-soo Jung, Hwaseong-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/439,944

(22) Filed: May 25, 2006

Related U.S. Application Data
(60) Provisional application No. 60/684,533, filed on May 26, 2005.

(30) Foreign Application Priority Data
Aug. 24, 2005 (KR) 2005-78016
Dec. 7, 2005 (KR) 2005-118841

(51) Int. Cl. G06F 15/16

(52) U.S. Cl. 709/217

(57) ABSTRACT

An information storage medium including an application for obtaining metadata for a disc library, and an apparatus and a method of obtaining the metadata. The information storage medium includes a network application to download metadata for a disc library from an external server to a reproducing apparatus for reproducing data from the information storage medium, wherein the metadata for a disc library has a structure including identifier information, version information, type information, disc information, and title information and is stored in the reproducing apparatus. Accordingly, the metadata for a disc library can be downloaded from the external server via a network.

### CROSS-REFERENCE TO RELATED APPLICATIONS

This application claims the benefit of Korean Patent Application No. 2005-78016, filed on Aug. 24, 2005, and 2005-118841, filed on Dec. 7, 2005, in the Korean Intellectual Property Office, and the benefit of U.S. Provisional Patent Application No. 60/684,533, filed on May 26, 2005, in the U.S. Patent and Trademark Office, the disclosures of which are incorporated herein in its entirety by reference.

### BACKGROUND OF THE INVENTION

1. Field of the Invention

Aspects of the present invention relate to a storage medium including an application for obtaining metadata and a method and apparatus for obtaining metadata. More specifically, aspects of the present invention relate to an information storage medium including an application for obtaining metadata for use in forming a disc library from an external server and a method and apparatus for obtaining the metadata.

2. Description of the Related Art

Storage media, such as DVDs, store audio-visual (AV) data, or a moving picture data stream, that include video data, audio data, and, sometimes, a subtitle that have been compressed and encoded according to a standard, such as the Moving Picture Experts Group (MPEG). Storage media also store additional information, such as the encoding properties of the moving picture data stream or the reproducing sequence of a moving picture.

However, as for conventional information storage media, its physical characteristics and any information relating to a moving picture stored therein are incapable of being separately stored in a reproducing apparatus and thus unable to be searched for by a user. Examples of the information relating to the moving picture include the type of the information storage medium, the names of the titles of the moving picture, actors and actresses playing in the moving picture, the genre of the moving picture, the producer thereof, etc. Furthermore, the information about the conventional information storage medium and the information relating to the moving picture cannot be updated with new information, and information about a newly released disc cannot be used.

### SUMMARY OF THE INVENTION

Aspects of the present invention provide an information storage medium and an application used to download metadata from a server for use in forming a disc library.

Additional aspects and/or advantages of the invention will be set forth in part in the description which follows and, in part, will be obvious from the description, or may be learned by practice of the invention.

According to an aspect of the present invention, there is provided a reproducing apparatus comprising an apparatus disposed therein that downloads metadata for a disc library from an external server to the local storage of the reproducing apparatus according to an application stored in an information storage medium played back by the reproducing apparatus, and displays the downloaded metadata to a user.

According to another aspect of the present invention, there is provided a method comprising downloading metadata for a disc library from an external server to a local storage of a reproducing apparatus according to an application stored in an information storage medium played back by the reproducing apparatus, and displaying the metadata to a user.

According to yet another aspect of the present invention, there is provided an information storage medium including information about a network application to control metadata for a disc library to be downloaded from an external server to a reproducing apparatus for reproducing data from the information storage medium, wherein the metadata for a disc library is stored in the reproducing apparatus and indicates information about the data stored in the information storage medium, the metadata for a disc library comprising at least one of: identifier information identifying the metadata for a disc library; version information indicating the version of the metadata for a disc library; type information indicating the type of the metadata for a disc library; disc information indicating information about the contents stored in the information storage medium; and title information indicating information about a plurality of titles stored in the information storage medium.

The metadata for a disc library may, although not necessarily, include thumbnail information used to provide a thumbnail image.

The type information may, although not necessarily, include at lease one of: a history type indicating metadata for a disc library about an information storage medium that has ever been played back by the reproducing apparatus; and a newly released type indicating metadata for a disc library about an information storage medium that is newly released, wherein the metadata can be downloaded from the external server.

The information storage medium may, although not necessarily, further include information about a storage management application which manages the local storage of the reproducing apparatus in order to download the metadata for a disc library from the external server to the local storage, wherein the storage management application comprises a storage management API function for extracting information necessary for the download from the local storage.

The network application may, although not necessarily, include a network API function which controls the information necessary for the download to be transmitted to the external server together with information about a request for the metadata for a disc library and to-be-downloaded metadata to be selected from the external server based on the information necessary for the download.

The information storage medium may, although not necessarily, further include: information about a reproducing application for reproducing the metadata for a disc library from the local storage of the reproducing apparatus; and additional information necessary for providing the metadata for a disc library to a user interface.

The reproducing application information may, although not necessarily, further include program data used to check if the reproducing apparatus supports a disc library.

According to still another aspect of the present invention, there is provided a method of obtaining metadata for a disc library, the method comprising: extracting information necessary for downloading the metadata from an external server, from a local storage of a reproducing apparatus that reproduces data from the information storage medium; transmitting the information necessary for the download to the external server, together with a request to download the metadata for a disc library; and downloading the metadata from the external server based on the information necessary for the download.

According to another aspect of the present invention, there is provided an apparatus for obtaining metadata for a disc library, the apparatus comprising: a local storage storing metadata for a disc library read out from the information storage medium or downloaded from an external server; a disc library manager controlling a connection to the server so that information necessary for downloading metadata for a disc library from the external server is extracted from the local storage and that the metadata for a disc library is downloaded from the external server based on the necessary information; and a network unit downloading the metadata for a disc library from the external server.

According to another aspect of the present invention, there is provided a reproducing apparatus that obtains metadata for a disc library, the apparatus comprising: a local storage storing metadata for a disc library read out from the information storage medium or downloaded from an external server; a disc library manager controlling the external server so that information necessary for downloading metadata for a disc library from the external server is extracted from the local storage and that the metadata for a disc library is downloaded from the external server based on the necessary information; a network unit downloading the metadata for a disc library from the external server; a presentation engine decoding a moving picture stream stored in the information storage medium; and an audio-visual (AV) renderer receiving the decoded data from the presentation engine, mixing the decoded data, outputting the data mixture, and outputting the metadata for a disc library received from the disc library manager.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram of a system that forms a disc library using metadata received from an information storage medium, according to an embodiment of the present invention;

FIG. 2 illustrates a screen that provides a disc library, according to an embodiment of the present invention;

FIG. 3 is a block diagram of a structure of a reproducing apparatus shown in FIG. 1 which obtains metadata from an external server, according to an embodiment of the present invention;

FIG. 4 illustrates a system for downloading metadata for a disc library, according to an embodiment of the present invention;

FIG. 5 illustrates a structure of metadata for a disc library, according to an embodiment of the present invention; and

FIG. 6 illustrates a method of downloading and obtaining metadata for a disc library, according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below to explain the present invention by referring to the figures

Metadata mentioned in this specification denotes metadata used to form a disc library. The disc library denotes data (or a file) that includes medium information about an information storage medium (e.g., an optical disc), release information thereabout, regional code information, information about audio and/or subtitles that are supported, and additional information about the unit in which a moving picture stored in the information storage medium is reproduced (e.g., titles). The disc library is stored in a local storage of the reproducing apparatus.

FIG. 1 is a schematic diagram of a system that forms a disc library 140 using metadata 120 obtained from an information storage medium 110, according to an embodiment of the present invention. In FIG. 1, metadata 120 for the disc library 140 stored in an information storage medium 110, includes disc identification information, title information, version information, and linked thumbnail information. The disc identification information denotes information about the whole information storage medium, such as, the format and name of the information storage medium 110, the number of titles of a moving picture stored in the information storage medium 110, information about the release of the information storage medium 110, a regional code, etc. The title information may include the names of the titles, actors and actresses playing in the moving picture, the genre of the moving picture, the producer thereof, the parental guide thereof, etc. The version information indicates the version of the metadata 120 for the disc library 140 to be checked for a future update. The thumbnail information denotes an image associated with the title information.

When the information storage medium 110 including the metadata 120 for the disc library 140 is inserted into a reproducing apparatus 130, the reproducing apparatus 130 checks if its local storage has enough space to store the metadata 120 and secures a storage area that is distinguished from the other areas by the disc identifier information of the information storage medium 110. The metadata 120 is stored in the storage area that is distinguished by the disc identifier information of the information storage medium 110.

Hence, even when the information storage medium 110 is removed from the reproducing apparatus 130, a specific information storage medium 110 or a specific title can be searched using a disc library 140, which cataloges metadata 120 stored in the local storage on a disc-by-disc basis. An application used to display the disc library 140 through a user interface is a resident application included in the reproducing apparatus 130.

However, when the information storage medium 110 includes information about a reproducing application for providing the metadata 120 for the disc library 140 and style information as additional information needed to form a user interface used to display the metadata 120, the display of the disc library 140 to a user may be executed according to the reproducing application stored in the information storage medium 110. To achieve this, the reproducing application stored in the information storage medium 110 may define and execute an application programming interface (API) function for checking if the reproducing apparatus 130 provides the disc library 140, and an API function for reading the metadata 120 cataloged in the disc library 140 of the reproducing apparatus 130.

FIG. 1 illustrates a process in which the metadata 120 for the disc library 140, whose history type has been set in an initialization stage of playback of the information storage medium 110, is stored in the local storage of the reproducing apparatus 130. As described later, the reproducing apparatus 130 may also download metadata 120 for a disc library from an external server (not shown) to the local storage, so that the history type metadata 120 which has been read from the information storage medium 110 and included in the disc library 140 may be updated or newly-released type metadata 120 about a newly-released information storage medium 110 may be added to the local storage.

To achieve this, metadata 120 for a disc library may further comprise type information for distinguishing metadata 120 from one another according to the type. This will be described in greater detail with reference to FIG. 5.

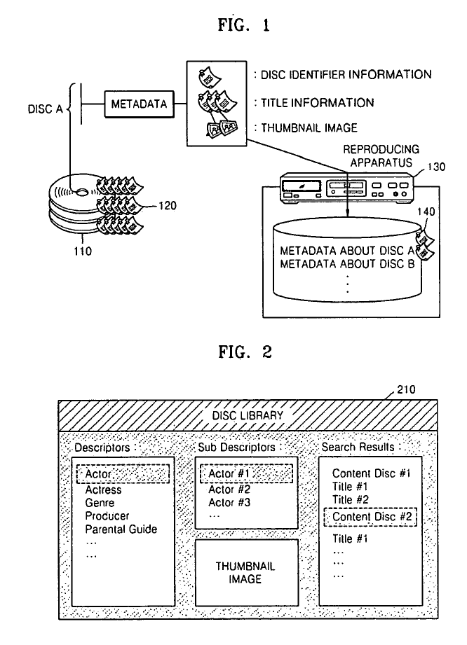

FIG. 2 illustrates a screen 210 that displays a disc library 140 according to an embodiment of the present invention. The screen 210 displays the disc library 140 upon execution of the resident application stored in the reproducing apparatus 130, or execution of an application stored in an information storage medium 110. The screen 210 may provide descriptors, sub-descriptors, search results, and a thumbnail image linked to the search results.

In FIG. 2, information provided to the descriptors includes the names of actors and actresses playing in a movie stored in the information storage medium 110, the genre of the movie, the producer thereof, the parental guide thereof, etc. When a user clicks “actor” among the information provided in the descriptors, the reproducing apparatus 130 provides a list of actors' names to the user through the sub-descriptors. When the user clicks “Actor #1”, the screen 210 displays, as search results, information about the information storage mediums 110 which store the movies in which the actor corresponding to “Actor #1” plays, and a thumbnail image linked to the search results.

FIG. 3 is a block diagram of a structure of the reproducing apparatus 130 which obtains metadata 120 from an external server, according to an embodiment of the present invention. The reproducing apparatus 130 includes a local storage 320, a read unit 325, a disc library manager 330, a network unit 340, a presentation engine 350, and an audio-visual (AV) renderer 360.

The local storage 320 stores metadata 120 for a disc library read out from information storage media 310 or downloaded from the external server.

The read unit 325 reads the metadata 120 stored in the information storage medium 310 and the local storage 320 and controls the transmission and reception of data among the components of the reproducing apparatus 130. Instead of forming the read unit 325 as an independent functional unit as shown in FIG. 3, each of the components may be constructed to perform the function of the read unit 325.

The disc library manager 330 manages the read unit 325 to read out the metadata 120 for the disc library 140 from the information storage medium 310 and to store the read-out metadata 120 in the local storage 320. The disc library manager 330 interprets and processes an input made by a user who wants the disc library 140, reads information about the desired disc library 140 from the local storage 320, produces a user interface using the read-out information, and transmits the user interface to the AV renderer 360. The disc library manager 330 may also interpret and process additional data (e.g., a markup document, program data, style information, etc.) other than moving picture information stored in the information storage medium 310. The disc library manager 330 may achieve the control of the read unit 325 to read the metadata 120 for the disc library 140 from the local storage 320 by executing an API function that interfaces the disc library manager 330 with a reproducing application stored in the information storage medium 310. In this case, the read-out metadata 120 can be provided in the form of a user interface by using information about the reproducing application and style information which are stored in the information storage medium 310.

Furthermore, the disc library manager 330 extracts from the local storage 320 information necessary for downloading the metadata 120 for the disc library 140. More specifically, the disc library manager 330 extracts from the local storage 320 identifier information, type information, and version information that is necessary for downloading the metadata 120 for the disc library 140. The disc library manager 330 also checks information about a spare space of the local storage 320 in which the downloaded metadata 120 can be stored.

To download metadata 120 for the disc library 140 from an external server 410, the disc library manager 330 executes an application to download the metadata 120 that defines a storage management API function which manages the local storage 320. The storage management API function may be defined in the following way:

Request_Space ( ) indicates that the disc library manager 330 returns a recordable space to the application through an API requested by the application stored in the information storage medium 310.

Get_inform_DiscLibs ( ) indicates that the application enables the disc library manager 330 to extract the identifier, version, and type of the metadata 120 for the disc library 140 stored in the local storage 320.

Update_Library (lists of Disc Library metadata) indicates that, among a list of downloadable metadata 120 that are provided by the external server 410, metadata 120 for a disc library 140 that is not stored in the local storage 320 is added to the metadata 120 stored in the local storage 320, and metadata 120 for a disc library 140 that is stored in the local storage 320 updates the metadata 120 stored in the local storage 320.

The network unit 340 transmits the identifier information, version information, type information, and information about the spare space of the local storage 320 in which the metadata 120 downloaded can be stored. This information is originally extracted by the disc library manager 330. The network unit transmits this information to the external server, together with a request for the download of metadata 120 for a disc library 140.

The disc library manager 330 controls a connection of the network unit 340 with the external server so as to extract a list of metadata 120 other than the metadata 120 read from the information storage medium 310 and stored in the local storage 320, and to extract metadata 120 to be downloaded based on the space information. Then, the disc library manager 330 downloads the extracted metadata 120 to the local storage 320 and, if necessary, updates the existing metadata 120 of the local storage 320 with the downloaded metadata 120.

The downloadable metadata 120 found by the external server 410 may include metadata 120 that has new information about a previously played back information storage medium 310 updating a current version of history type metadata 120 for a disc library 140. The downloadable metadata 120 found by the external server 410 may also include newly-released type metadata 120 for a disc library 140, i.e., metadata 120 about an information storage medium 310 that has never been played back or is newly released. The metadata 120 for a disc library 140 includes type information in order to distinguish itself from other types. Hence, history type disc libraries can be distinguished from newly-released type disc libraries.

The disc library manager 330 may control the metadata 120 for a newly-released disc library to be stored in an area of the local storage 320 other than the area for storing a history type disc library, in order for a user to distinguish each type of disc library from the other. If metadata 120 downloaded from the external server is history type metadata 120 with a version higher than that of metadata 120 for a history type disc library read from an information storage medium 310 and stored in the local storage 320, the downloaded metadata 120 may be overwritten to the area for storing metadata 120 for a history type disc library read from an information storage medium 310. In another way, the disc library manager 330 may control newly-released type metadata 120 downloaded from the external server 410 to be allocated with a file name different from the file name for history type metadata 120, i.e., with an extension name.

As such, the storage of metadata 120 for a history type disc library and metadata 120 for a newly-released type disc library in different ways contributes to an efficient user interface. For example, when only history type metadata 120 is wanted, the disc library manager 330 does not need to search for all of the metadata 120 stored in the local storage 320.

The presentation engine 350 decodes a moving picture stream stored in the information storage medium 310. The AV renderer 360 receives the decoded data from the presentation engine 350, mixes the decoded data, and outputs the data mixture. The AV renderer 360 also outputs the metadata for a disc library received from the disc library manager 330.

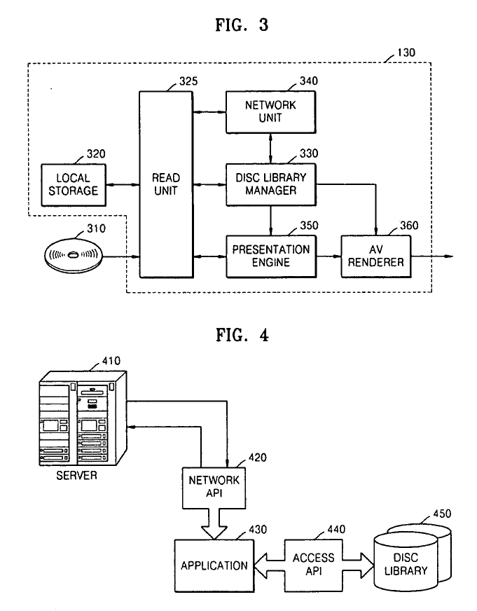

FIG. 4 is a block diagram of a functional structure of a metadata downloading system according to an embodiment of the present invention. The system includes an external server 410, an application 430, stored in the information storage medium 310, for downloading metadata 120 from the external server 410, and a disc library 450 stored in a reproducing apparatus. A method in which a network application is executed to update the metadata 120 in the disc library 450 stored in a reproducing apparatus 130 or add new metadata 120 to the disc library 450 stored in the reproducing apparatus, and a method in which the metadata 120 for a disc library 450 is provided to a user will now be described with reference to FIGS. 3 and 4.

The application 430 includes the aforementioned storage management API function 440 so as to extract the identifier, version, and type of the metadata 120 for the disc library 450 stored in the reproducing apparatus 130 and information about the spare space where downloaded metadata 120 can be stored.

The application 430 includes a network API function 420 for transmitting the extracted identifier, version, and type information and the extracted space information together with a request for metadata 120 for the disc library 450 to the external server 410. The application 430 also extracts from the external server 410 a list of metadata 120 other than the metadata 120 read from the information storage medium 310 and stored in the local storage 320 among downloadable metadata 120 that is found based on the identifier, version, and type information about the metadata 120 stored in the reproducing apparatus 130. The network API function 420 also bases the extraction of metadata 120 to be downloaded from the external server 410 on the space information. In the other various ways, the network API function 420 can extract metadata 120 to be downloaded from the external server 410.

The addition or update of metadata 120 will now be described. The identifier, version, type, and space information about the metadata 120 of the disc library 450, which are extracted by the disc library manager 330, are transmitted to the external server 410 via the network unit 340, together with the request for new metadata 120 for the disc library 450.

The external server 410 checks the version of the metadata 120 for the disc library 450 based on the information received from the network unit 340. When the metadata already exists in the reproducing apparatus 130, the external server 410 finds a list of metadata 120 other than the metadata 120 read from the information storage medium 310 and stored in the local storage 320 among the downloadable metadata 120. The external server 410 outputs the list of metadata to be downloaded to the reproducing apparatus 130 based on the space information.

The metadata 120 output by the external server 410 is transmitted to the disc library manager 330 via the network unit 340 and stored in a spare area of the local storage 320.

The management of a recording space, such as, the local storage 320, is executed by the disc library manager 330 of the recording apparatus 130, not by applications stored in information storage media, when considering the characteristics of the metadata 120 stored in the different information storage media 310 manufactured by different studios. Hence, the applications of the information storage media 310 are able to request from the disc library manager 330 information about the space of the local storage 320 where downloaded data can be stored, but are not allowed to delete specific metadata 120. Thus, arbitrary correction or deletion of the metadata 120 of the recording apparatus 130 by the applications of the information storage media 310 can be prevented.

The information storage medium 310 may include a reproducing application used to provide the disc library 450 stored in a reproducing apparatus 130 to users. An access API 440, which is program data included in the reproducing application, is used to extract metadata 120 using the disc library 450 of the reproducing apparatus. Hence, updated metadata and added metadata is extracted from the local storage 320 through the access API 440, and a disc library 450 including the extracted updated metadata can be provided to users by using the style information stored in the information storage medium 310. When the disc library 450 is provided using the reproducing application of the information storage medium 310, a user interface depending on a disc library provision scenario of a metadata producer can be provided.

FIG. 5 illustrates a structure of metadata 120 for a disc library 450, according to an embodiment of the present invention. The metadata 120 for a disc library 450 includes a disc library identifier 510, version information 520, type information 530, disc information 540, title information 550, and thumbnail information 560.

The disc library identifier 510 identifies the metadata 120 for a disc library 450 and may include a plurality of identifiers, such as, a studio identifier, a contents identifier, etc. The studio identifier identifies a studio which is the producer of the contents of a disc. The contents identifier identifies the disc and indicates UUID and the like.

The version information 520 indicates the version of the metadata 120 for a disc library. When the disc library identifier 510 of the metadata 120 for a disc library 450 is the same as that of the metadata 120 for a disc library 450 already stored in the reproducing apparatus 130, it is determined from the version information 520 whether the metadata 120 for a disc library 450 is the newest version or an old version.

The type information 530 is used to distinguish different types of metadata 120 for a disc library 450 therebetween. For example, as described above, when the reproducing apparatus 130 reproduces data from an information storage medium 310 having metadata 120 for a disc library 450, the metadata 120 for a disc library 450 which is stored in the local storage 320 during the initialization stage of the reproducing process is set as a history type. On the other hand, if the information storage medium 310 has never been reproduced by the reproducing apparatus 130, that is, is newly released, the metadata 120 for a disc library 450 downloadable from the external server 410 is set as a newly released type. Hence, the reproducing apparatus 130 may provide a user interface made up of only history type disc libraries or provide a user interface made up of only newly-released type disc libraries based on the type information 530.

History type metadata 120 for a disc library 450 may be distinguished from one another by the version information 520. In other words, the reproducing apparatus 130 can update history type disc libraries stored therein with history type metadata 120 of a new version downloaded from an external server 410. The type information 530 may indicate the types other than the history type and the newly released type.

The disc information 540 indicates information relating to the contents stored in the information storage medium 310, such as, the producer, the producing period, and actors and actresses, etc. The title information 550 indicates information relating to titles stored in the information storage medium 310. The thumbnail information 560 is used to provide a thumbnail image associated with the disc information 540 or the title information 550.

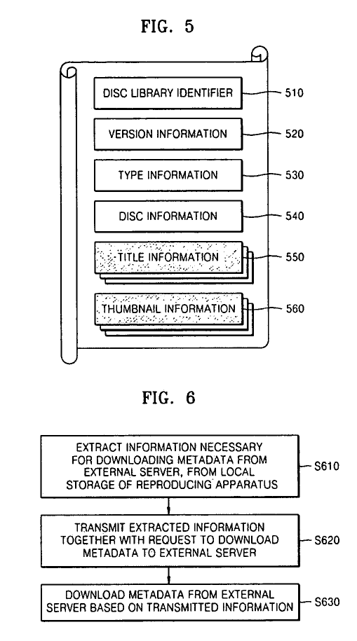

FIG. 6 illustrates a method of downloading and obtaining metadata 120 for a disc library 450, according to an embodiment of the present invention. In order to download metadata 120 for a disc library 450 from an external server 410 to a reproducing apparatus 130, according to an application 430 included in an information storage medium 310, information necessary for the download is first extracted from the local storage 320 of the reproducing apparatus 130, in operation S610. To achieve this operation, the application included in an information storage medium 310 requests the reproducing apparatus 130 for information about the spare space of the local storage 320 where the downloaded metadata 120 can be stored, and checks the requested space information. The information necessary for the download includes identifier information, type information, version information, and the space information.

Then, the extracted information together with a request to download the metadata 120 for a disc library 450 is transmitted to the external server 410, in operation S620. Next, the metadata 120 is downloaded from the external server 410, based on the transmitted information, to the local storage 320 of the reproducing apparatus 130, in operation S630.

As described above, an information storage medium 310 includes a network application that enables metadata 120 for a disc library 450 to be downloaded from an external server 410 so that the metadata 120 for a disc library 450 already stored in a reproducing apparatus 130 is updated with the downloaded metadata 120 or the downloaded metadata 120 is added to the metadata 120 for a disc library 450 stored in the reproducing apparatus 130.

Also, in an apparatus and method of obtaining metadata 120 according to the present invention, metadata 120 for a disc library 450 about a disc that has ever been played back is distinguished from metadata 120 for a disc library 450 about a newly released disc, and the distinguished metadata 120 is provided to users.

Furthermore, according to the present invention, metadata 120 for a disc library 450 extracted from an information storage medium 310 can be provided to users according to a reproducing application stored in the information storage medium 310.

Information storage media 310 include computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An information storage medium comprising a network application to download metadata for a disc library from an external server to a local storage of a reproducing apparatus for reproducing data from the information storage medium, wherein the metadata for the disc library is stored in the reproducing apparatus and indicates information about the data stored in the information storage medium.

2. The information storage medium as claimed in claim 1, wherein the metadata for the disc library comprises at least one of:
identifier information identifying the metadata for the disc library;
version information indicating a version of the metadata for the disc library;
type information indicating a type of the metadata for the disc library;
disc information indicating information about contents stored in the information storage medium; and
title information indicating information about a plurality of titles stored in the information storage medium.

3. The information storage medium as claimed in claim 1, wherein the metadata for the disc library comprises thumbnail information used to provide a thumbnail image.

4. The information storage medium as claimed in claim 2, wherein the type information comprises at lease one of:
a history type indicating metadata for the disc library about an information storage medium that has ever been played back by the reproducing apparatus; and
a newly released type indicating metadata for the disc library about an information storage medium that is newly released, wherein the metadata is downloadable from the external server.

5. The information storage medium as claimed in claim 1, further comprising a storage management application to manage the local storage of the reproducing apparatus in order to download the metadata for the disc library from the external server to the local storage, wherein the storage management application comprises a storage management API function to extract information necessary for the download from the local storage.

6. The information storage medium as claimed in claim 5, wherein the storage management API function returns a recordable space in the local storage of the reproducing apparatus to the storage management application.

7. The information storage medium as claimed in claim 5, wherein the storage management API function returns an identifier information, a version information, and a type information that is necessary to download the metadata for the disc library.

8. The information storage medium as claimed in claim 5, wherein the storage management API function adds metadata that is not stored in the local storage to the local storage, and updates metadata that is stored in the local storage.

9. The information storage medium as claimed in claim 5, wherein the network application comprises a network API function:
to transmit the information necessary for the download to the external server,
to transmit a request for the metadata for the disc library to the external server, and
to extract from the external server a list of metadata, other than the metadata read from the information storage medium and stored in the local storage, based on the information necessary for the download.

10. The information storage medium as claimed in claim 1, wherein the network application comprises:
a storage management API function to extract information necessary for the download from the local storage; and
a network API function:
to transmit the information necessary for the download to the external server,
to transmit a request for the metadata for the disc library to the external server, and
to extract from the external server a list of metadata, other than the metadata read from the information storage medium and stored in the local storage, based on the information necessary for the download.

11. The information storage medium as claimed in claim 10, wherein the storage management API function returns a recordable space in the local storage of the reproducing apparatus to the network application.

12. The information storage medium as claimed in claim 10, wherein the storage management API function returns an identifier information, a version information, and a type information that is necessary to download the metadata for the disk library.

13. The information storage medium as claimed in claim 10, wherein the storage management API function adds metadata that is not stored in the local storage to the local storage, and updates metadata that is stored in the local storage.

14. The information storage medium as claimed in claim 1, further comprising:
a reproducing application to reproduce the metadata for the disc library from the local storage of the reproducing apparatus; and
additional information necessary to provide the metadata for the disc library to a user interface.

15. The information storage medium as claimed in claim 14, wherein the reproducing application comprises program data used to check if the reproducing apparatus supports the disc library.

16. A method of obtaining metadata for a disc library that is information about the data stored in an information storage medium, the method comprising:
extracting information necessary to download the metadata from an external server, from a local storage of a reproducing apparatus that reproduces data from the information storage medium;
transmitting the information necessary to download to the external server, together with a request to download the metadata for the disc library; and
downloading the metadata from the external server to the local storage based on the information necessary to download.

17. The method as claimed in claim 16, wherein the extracting of the information necessary to download comprises:
requesting information about a recordable space of the local storage where the metadata for the disc library downloaded can be stored; and
checking the information about the recordable space of the local storage.

18. The method as claimed in claim 17, wherein the extracting of the information necessary to download further comprises extracting identifier information, type information, and version information about the metadata for the disc library.

19. The method as claimed in claim 18, wherein the downloading of the metadata comprises:
extracting a list of metadata, other than the metadata read from the information storage medium and stored in the local storage, among downloadable metadata that are found based on the information necessary to download.

20. The method as claimed in claim 19, wherein the downloading of the metadata further comprises downloading new-released type metadata for the disc library to a space, wherein:
new-released type metadata is metadata about an information storage medium that has never been played back;
history type metadata is metadata about an information storage medium that has ever been played back; and
the history type metadata is stored in an other space.

21. The method as claimed in claim 20, wherein a downloaded history type metadata overwrites a stored history type metadata if the downloaded history type metadata has version information higher than the stored history type metadata.

22. The method as claimed in claim 19, wherein the downloading of the metadata further comprises allocating a file name to a new-released type metadata and downloading the new-released type metadata with the file name, wherein:
new-released type metadata is metadata about an information storage medium that has never been played back;
history type metadata is metadata about an information storage medium that has ever been played back; and
the history type metadata has an other file name.

23. The method as claimed in claim 22, wherein a downloaded history type metadata overwrites a stored history type metadata if the downloaded history type metadata has version information higher than the stored history type metadata.

24. The method as claimed in claim 16, further comprising displaying the metadata downloaded to the local storage to users through a user interface defined by information stored in the information storage medium.

25. A reproducing apparatus that obtains metadata for a disc library that is information about data stored in an information storage medium, the reproducing apparatus comprising:
a local storage storing metadata for the disc library read out from the information storage medium and metadata for the disc library downloaded from an external server;
a disc library manager controlling a connection to the external server; and
a network unit downloading the metadata for the disc library from the external server.

26. The reproducing apparatus as claimed in claim 25, wherein the disc library manager obtains a space information about a recordable space of the local storage to which metadata is downloadable, and extracts identifier information, type information, and version information of the metadata for the disc library from the local storage.

27. The reproducing apparatus as claimed in claim 26, wherein the disc library manager extracts a list of metadata, other than the metadata read from the information storage medium and stored in the local storage, wherein the list of metadata is found by the external server based on the space information and the identifier information, type information, and version information of the metadata.

28. The reproducing apparatus as claimed in claim 25, wherein the disc library manager executes an application, provided in the information storage medium, to download the metadata for the disc library, the application comprising:
a storage management API function to extract information necessary to download from the external server, from the local storage; and
a network API function:
to transmit the information necessary to download from the external server, to the external server,
to transmit a request for the metadata for the disc library to the external server, and
to extract from the external server a list of metadata, other than the metadata read from the information storage medium and stored in the local storage, based on the information necessary to download from the external sever.

29. The reproducing apparatus as claimed in claim 28, wherein the storage management API function returns a recordable space in the local storage of the reproducing apparatus to the application.

30. The reproducing apparatus as claimed in claim 28, wherein the storage management API function returns an identifier information, a version information, and a type information that is necessary to download the metadata for the disk library.

31. The reproducing apparatus as claimed in claim 28, wherein the storage management API function adds metadata that is not stored in the local storage to the local storage, and updates metadata that is stored in the local storage.

32. The reproducing apparatus as claimed in claim 25, wherein the disc library manager stores the metadata for the disc library in an area of the local storage.

33. The reproducing apparatus as claimed in claim 32, wherein the disc library manager stores new-released type metadata for the disc library in a space, wherein:
new-released type metadata is metadata about an information storage medium that has never been played back;
history type metadata is metadata about an information storage medium that has ever been played back; and
the history type metadata is stored in an other space.

34. The reproducing apparatus as claimed in claim 33, wherein a downloaded history type metadata overwrites a stored history type metadata if the downloaded history type metadata has version information higher than the stored history type metadata.

35. The reproducing apparatus as claimed in claim 32, wherein the disc library manager allocates a file name to a new-released type metadata and stores the new-released type metadata with the file name, wherein:
new-released type metadata is metadata about an information storage medium that has never been played back;
history type metadata is metadata about an information storage medium that has ever been played back; and
the history type metadata has an other file name.

36. The reproducing apparatus as claimed in claim 35, wherein a downloaded history type metadata overwrites a stored history type metadata if the downloaded history type metadata has version information higher than the stored history type metadata.

37. The reproducing apparatus as claimed in claim 25, wherein the disc library manager reads the metadata for the disc library from the information storage medium that the reproducing apparatus plays back, stores the metadata for the disc library in the local storage, and reads the metadata for the disc library from the local storage so as to display a user interface.

38. The reproducing apparatus as claimed in claim 25, wherein the disc library manager displays the metadata stored in the local storage to users through a user interface defined by information stored in the information storage medium.

39. The reproducing apparatus as claimed in claim 25, further comprising a presentation engine decoding a moving picture stream stored in the information storage medium.

40. The reproducing apparatus as claimed in claim 39, further comprising an audio-visual (AV) renderer receiving the decoded data from the presentation engine, mixing the decoded data, outputting the data mixture and outputting the metadata for the disc library received from the disc library manager.

41. The reproducing apparatus as claimed in claim 25, further comprising a read unit to control the transmission and reception of data therein and to read the metadata stored in the information storage medium.

42. The reproducing apparatus as claimed in claim 41, wherein the read unit reads the metadata for the disc library from the information storage medium that the reproducing apparatus plays back and stores the metadata for the disc library in the local storage.

43. A reproducing apparatus that obtains metadata for a disc library that is information about the data stored in an information storage medium, the apparatus comprising:
a local storage storing metadata for the disc library read out from the information storage medium and metadata for the disc library downloaded from an external server;
a disc library manager controlling a connection to the external server;
a network unit downloading the metadata for the disc library from the external server;
a presentation engine decoding a moving picture stream stored in the information storage medium; and
an audio-visual (AV) renderer receiving the decoded data from the presentation engine, mixing the decoded data, outputting the data mixture and outputting the metadata for the disc library received from the disc library manager.

44. The reproducing apparatus as claimed in claim 43, wherein the disc library manager obtains a space information about a recordable space of the local storage to which metadata can be downloaded, and extracts identifier information, type information, and version information of the metadata for the disc library from the local storage.

45. The reproducing apparatus as claimed in claim 44, wherein the disc library manager extracts a list of metadata, other than the metadata read from the information storage medium and stored in the local storage, wherein the list of metadata is found by the external server based on the space information and the identifier information, type information, and version information of the metadata.
